(19) United States
(12) Patent Application Publication
(10) Pub. No.: US 2009/0109014 A1
(43) Pub. Date: Apr. 30, 2009

(54) System and method for signaling personal messages by a driver of a motor vehicle

(76) Inventor: Julius M. Jones, Los Angeles, CA (US)

Correspondence Address: JAMES RAY & ASSOCIATES, 2640 Pitcaim Road, Monroeville, PA, 15146, US

(21) Appl. No.: 12/288,904

(22) Filed: Oct. 24, 2008

Related U.S. Application Data
(60) Provisional application No. 60/982,907, filed on Oct. 26, 2007.

(51) Int. Cl. B60Q 1/26

(52) U.S. Cl. 340/468

(57) ABSTRACT

A system for signaling a pair of personal messages by a driver of a motor vehicle in a reward direction includes a first signal indicator energized to intermittently emit a first color light and disposed in close proximity to one upper corner of a rear window, a second signal indicator energized to intermittently emit a second color light and disposed in close proximity to an opposed upper corner of the rear window, and a third signal indicator energized to intermittently emit a third color light and juxtaposed with the second signal indicator. Two switches are mounted on a steering wheel with one switch operable to selectively energize and deenergize the first signal indicator and an opposed switch operable to selectively energize and deenergize each of the second and third signal indicators, whereby the second and third signal indicators alternatively flash upon activation.

### CROSS-REFERENCE TO RELATED APPLICATIONS

This application is related to and claims priority from Provisional Patent Application Ser. No. 60/982,907 filed on Oct. 25, 2007.

### FIELD OF THE INVENTION

The present invention relates, in general, to light indicating systems for motor vehicle and, more particularly, this invention relates to a system and method for signaling personal message by a driver of a leading motor vehicle in a rearward direction to a driver of a trailing vehicle.

### BACKGROUND OF THE INVENTION

As is generally well known, more drivers than ever before are traveling longer distances to and from work and school each day. With jammed highways and backed up interstates, road rage is at an all-time high. While many drivers are courteous and offer a wave of a hand when passing or changing lanes, some, if not most, drivers are too distracted to see that this is a method of expressing gratitude and may be slighted at the driver's movement. Some drivers may inadvertently cut off another driver in order to make a turn or move from one lane to another. Waving the hand or flashing the lights is a normal method for apologizing while operating the motor vehicle but this method is not always noticed.

Prior to the conception and development of the present invention, efforts have been made in allowing the driver of a leading motor vehicle to communicate at least one personal message. For example, U.S. Pat. No. 5,905,434 issued to Steffan et al. and U.S. Pat. No. 6,553,285 issued to Bahmad provide a display that is mounted adjacent a center of the rear window in close proximity to a lower edge thereof and which is remotely operable from a control panel mounted on a dashboard for displaying at least one message in a rearward direction that can be read by a driver of a trailing vehicle. While such displays are capable of communicating the intent of the driver, the need to read displayed messages by the driver of the trailing vehicle may distract his or her attention from concentrating on driving conditions.

U.S. Pat. No. 5,663,707 issued to Bartillucci discloses a signaling light assembly that is visible through the rear window of the motor vehicle and that includes a primary electrically energizable signaling light unit having a first array of green light-emitting diodes, a second array of red light-emitting diodes, and a third array of yellow light-emitting diodes. The signaling light assembly is operable, by way of pressure sensitive and other type switches and logic circuitry, upon actuation of vehicle controls such as an accelerator pedal, a brake pedal, a lever of the vehicle's transmission system, and a turn signal lever. The signaling light assembly provides an apparatus primarily developed for the purpose of signaling a lead driver's intent in a rearward direction from the rear window of the vehicle and further utilizing a trailing driver's conventional attention to the rear window and associated brake light to indicate to him or her that the lead driver is preparing for a turn. However, the positioning of the signaling light assembly adjacent the center of the rear window in close proximity to the lower edge thereof has been found to interfere with positioning of signaling lights in a low enforcement vehicle.

Furthermore, the prior art signaling and communication systems are characterized by greater than desired complexity and cost.

Therefore, there is a need for an improved system and method for signaling at least one personal message by a driver of a leading motor vehicle in a reward direction to a driver of a trailing vehicle.

### SUMMARY OF THE INVENTION

According to one aspect, the invention provides a system for signaling a pair of personal messages by a driver of the motor vehicle in a reward direction. The system includes a first signal indicator having a predetermined shape and energized to intermittently emit a first predetermined color light in the rearward direction, the first color light defining a first personal message. The first signal indicator is disposed in a predetermined position and a predetermined distance from one upper corner of a rear window of the motor vehicle. A second signal indicator is also provided and is energized to intermittently emit a second predetermined color light in the rearward direction. The second signal indicator is disposed in a predetermined position and a predetermined distance from the one or an opposed upper corner of the rear window of the motor vehicle. There is a third signal indicator having a predetermined shape and energized to intermittently emit a third predetermined color light in the rearward direction. The third signal indicator is juxtaposed with the second signal indicator. At least one switch is operatively mounted on one of a steering wheel and a dashboard of the motor vehicle. The at least one switch is manually and selectively operable to selectively energize and deenergize the first signal indicator and is further selectively operable to selectively energize and deenergize each of the second and third signal indicators, whereby the second and third signal indicators alternatively flash upon activation. The alternative flashing of the second and third signal indicators defines a second personal message. Each of the first, second and third signal indicators includes a hollow housing having an open side, an adhesive for affixing the housing directly to an interior surface of the rear window and positioning the open side thereabout, a light source mounted within the housing and connected to a source of electric power, the light source operable to emit a light beam upon operation of the at least one switch, and a cover covering the open side of the housing and enabling passage of the light beam therethrough.

In accordance with another aspect, the present invention provides a system for signaling at least one personal message by a driver of the motor vehicle in a reward direction. The system includes a first signal indicator having a predetermined shape and energized to intermittently emit a yellow color light in the rearward direction defining a first personal message. The first signal indicator is disposed in a predetermined position and a predetermined distance from one upper corner of a rear window of the motor vehicle. A second signal indicator is also provided and is energized to intermittently emit a green color light in the rearward direction. The second signal indicator is disposed in a predetermined position and a predetermined distance from the one or an opposed upper corner of the rear window of the motor vehicle. There is a third signal indicator having a predetermined shape and energized to intermittently emit a red light in the rearward direction. The third signal indicator is juxtaposed with the second signal indicator. A first switch is operatively mounted on a steering wheel of the motor vehicle and is manually operable to selectively energize and deenergize the first signal indicator. An exposed surface of the first switch has a yellow color. A second switch is operatively mounted on the steering wheel of the motor vehicle in juxtaposed relationship with the first switch. The second switch is manually operable to selectively energize and deenergize each of the second and third signal indicators, whereby the second and third signal indicators alternatively flash upon activation defining a second personal message. An exposed surface of the second switch has a combination of green and red colors. Each of the first, second and third signal indicators includes a hollow housing having an open side, an adhesive for affixing the housing directly to an interior surface of the rear window and positioning the open side thereabout, a light source mounted within the housing and connected to a source of electric power, the light source operable to emit a light beam upon operation of the at least one switch, and a cover covering the open side of the housing and enabling passage of the light beam therethrough.

In accordance with a further aspect, the present invention provides a method for signaling a pair of personal messages by a driver of the motor vehicle in a reward direction. The method includes the step of mounting a first signal indicator in close proximity to one upper corner of a rear window of the motor vehicle. Next, mounting a second signal indicator in close proximity to one of the one upper corner and an opposed upper corner of the rear window of the motor vehicle. Then, mounting a third color signal indicator in a juxtaposed relationship with the second signal indicator. Mounting at least one control switch on one of a steering wheel and a dashboard of the motor vehicle. Then, operably connecting the at least one control switch to each of the first, second and third signal indicators. Next, signaling, by way of the first signal indicator, a first personal message. Finally, signaling, by way of the second and third signal indicators, a second personal message.

### OBJECTS OF THE INVENTION

It is, therefore, one of the primary objects of the present invention to provide a system for signaling at least one personal message by a driver of a motor vehicle in a reward direction.

Another object of the present invention is to provide a system for signaling at least one personal message by a driver of a motor vehicle in a reward direction that includes a trio of distinct color light assemblies.

Yet another object of the present invention is to provide a system for signaling at least one personal message by a driver of a motor vehicle in a reward direction that does not interfere with position and operation of rear lights on a law enforcement vehicle.

A further object of the present invention is to provide a system for signaling at least one personal message by a driver of a motor vehicle in a reward direction that is manually operable by way of at least one switch mounted on a steering wheel or a dashboard.

Yet a further object of the present invention is to provide a system for signaling at least one personal message by a driver of a motor vehicle in a reward direction that is economical to manufacture.

An additional object of the present invention is to provide a system for signaling at least one personal message by a driver of a motor vehicle in a reward direction that is simple to use.

Another object of the present invention is to provide a system for signaling at least one personal message by a driver of a motor vehicle in a reward direction that can be simply and economically installed on motor vehicles presently in use.

In addition to the several objects and advantages of the present invention which have been described with some degree of specificity above, various other objects and advantages of the invention will become more readily apparent to those persons who are skilled in the relevant art, particularly, when such description is taken in conjunction with the attached drawing Figures and with the appended claims.

### BRIEF DESCRIPTION OF THE DRAWINGS

FIG. 1 illustrates the present invention with signal indicators mounted adjacent each upper corner of the rear window of the motor vehicle;

FIG. 2 illustrates the present invention with signal indicators mounted adjacent one upper corner of the rear window of the motor vehicle;

FIG. 3 illustrates the present invention with control switch mounted either on the steering wheel or the dashboard of the motor vehicle; and

FIG. 4 illustrates side elevation view of the signal indicator of the present invention.

### BRIEF DESCRIPTION OF THE VARIOUS EMBODIMENTS OF THE INVENTION

Prior to proceeding to the more detailed description of the present invention, it should be noted that, for the sake of clarity and understanding, identical components which have identical functions have been identified with identical reference numerals throughout the several views illustrated in the drawing figures.

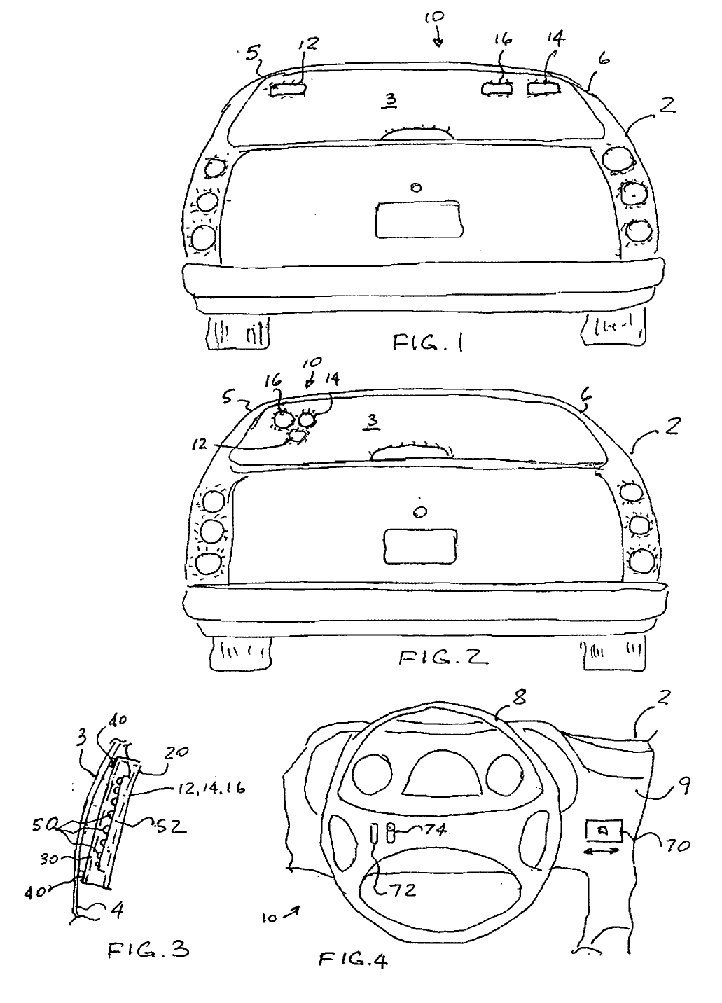

The best mode for carrying out the invention is presented in terms of its present embodiments, herein depicted within FIGS. 1 through 4. However, the invention is not limited to the described embodiments, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

The present invention provides a driver of a leading motor vehicle with a system and a method for signaling gratitude and apology to a driver of a trailing vehicle in order to reduce road rage and increase tolerance.

Reference is now made, to FIGS. 1-4, wherein there is shown a system, generally designated as 10, for signaling at least one personal message by a driver of a motor vehicle 2 in a reward direction. The system 10 includes a first signal indicator 12 having a predetermined shape and energized to intermittently emit a first predetermined color light in the rearward direction. The presently preferred first predetermined color is yellow and the first signal indicator 12 is provided to signal a first personal message, being a message of apology (such as in “sorry”) to the driver of a tailing vehicle (not shown). A second signal indicator 14 is provided and also has a predetermined shape. The second signal indicator 14 is energized to intermittently emit a second predetermined color light in the rearward direction. The presently preferred second predetermined color is green. There is also a third signal indicator 16 that has a predetermined shape and is energized to intermittently emit a third predetermined color light in the rearward direction. The presently preferred third predetermined color is red. The combination of red and green colors is meant to signal a second personal message, being a message of gratitude (as in “thank you”) to the driver of the tailing vehicle (not shown). The present invention also contemplates that other colors can be used for signaling such messages.

In accordance with one embodiment of the invention illustrated in FIG. 1, the first signal indicator 12 is disposed in a predetermined position and a predetermined distance from one upper corner 5 of a rear window 3 of the motor vehicle 2. Preferably, the first signal indicator 12 is disposed in close proximity to such upper corner 5 so as to not obstruct a rear view by the driver of the motor vehicle 2 while accommodating generally curved shape of such corner 5. The second signal indicator 14 is disposed in a predetermined position and a predetermined distance from an opposed upper corner 6 of the rear window 3 of the motor vehicle 2. The third signal indicator 16 is juxtaposed, preferably in a horizontally direction, with the second signal indicator 14. Both the second and third signal indicators are mounted in close proximity to the upper corner 6.

In accordance with another embodiment of the invention illustrated in FIG. 1, all three signal indicators 12, 14 and 16 are clustered in a predetermined position and a predetermined distance from, preferably being mounted in close proximity to, one upper corner, referenced with numeral 5 in FIG. 2.

Now in a particular reference to FIG. 3, each signal indicator 12, 14, 16 includes a hollow housing 20 having an open side. A cover 30 is provided for covering the open side of the housing 20 and enabling passage of the light beam therethrough. An adhesive 40 is provide for affixing the housing 20 directly to an interior surface 4 of the rear window 3 and positioning the cover 30 thereabout. A light source 50 is mounted within the housing 20 and is connected to a source of electric power (not shown), which is preferably the electric power supply system of the motor vehicle 2. The light source 50 may be of any conventional type including at least one incandescent bulb or a light emitting diode (LED). Preferably, the light source 50 is such LED and further preferably an array of LEDs mounted on a control circuit 52 to increase life and reduce manufacturing costs of each signal indicator 12, 14, 16. However, the present invention also contemplates the use of a halogen light source 50. The light source 50 is operable to emit a light beam. The material of the cover 30 depends on the type of the light source 50. For example, if the light source 50 is the LED emitting one of such first, second or third colors, the cover 30 may be made from a translucent or transparent glass, plastic or any other material capable of passing the light beam therethrough. When the light source 50 is the conventional incandescent bulb, the cover 30 will be adapted with the color of the respective signal indicator.

Although the signal indicators 14 and 16 are shown in FIG. 1 as being independently disposed about one another, they may be mounted within a common housing to reduce manufacturing and installation costs. Likewise, the signal indicators 12, 14 and 16 of FIG. 2, may be mounted within a common housing.

Next, in a particular reference to FIG. 4, the system 10 also includes at least one switch operatively mounted on one of a steering wheel 8 and a dashboard 9 of the motor vehicle 2. The at least one switch is manually and selectively operable to selectively activate and deactivate the first signal indicator 12 and is further selectively operable to selectively activate and deactivate each of the second and third signal indicators, 14 and 16 respectively, causing alternative flashing thereof upon activation. The at least one switch may be of any conventional switch design. For example, the at least one switch may be of a slide switch type 70 and being operable in one end position to intermittently energize the first signal indicator 12 and operable in the second end position to intermittently and alternatively energize the combination of the second and third signal indicators, 14 and 16 respectively. It is also within the scope of the present invention to provide a pair of switches 72, 74 of any conventional type, wherein a first one of such pair of switches, labeled as 72, is provided for operating the first signal indicator 12, while the second one of the pair of switches, labeled as 74, is provided for operating the second and third signal indicators, 14 and 16 respectively. In this embodiment, at least an exposed visible portion of the first switch 72 will be adapted with a yellow color of the first signal indicator 12 and at least an exposed visible portion of the second switch 74 will be adapted with the green and red colors of the second and third signal indicators, 14 and 16 respectively. Preferably, the switches 72, 74 are of a pressure sensitive type and are mounted on the steering wheel 8 in direct reach of the driver as to provide for ease and convenience of activating the signal indicators 12, 14 and 16.

Although the present invention has been shown in terms of the signal indicators having a rectangular shape of FIG. 1 or a round shape of FIG. 2, it will be apparent to those skilled in the art, that the present invention may employ other signal indicators shapes, such as square, hexagon, triangle, or the shapes having at least a partially curved or countered peripheral edge.

The positioning of the signal indicators 12, 14 and 16 in closed proximity to the upper corner or corners of the rear window 3 distinguishes the present invention from a general position of the lights near the lower edge of the rear window on low enforcement vehicles. While the present invention contemplates use of other light colors, it restrains from using blue color lights so as to further distinguish from such color lights used on the low enforcement vehicles. The flashing (on-off) pattern of each signal indicator 12, 14 and 16 is also set to differ from the flashing pattern employed on low enforcement or emergency vehicles. The operating duration of each signal indicator 12, 14 and 16 is relatively short, generally being about a second or less, so as to resemble a flicker of quick waving of the hand and distinguish the signaling from operation of conventional turning signals.

The flashing pattern of the signal indicators 12, 14 and 16 of the present invention for a relatively short duration of time is advantageous for communicating the intents of the driver of the leading motor vehicle 2 to the driver of the tailing vehicle (not shown) so that such intent will be easily understood and the driver of the trailing vehicle (not shown) will not be distracted from concentrating on driving conditions.

Thus, the present invention has been described in such full, clear, concise and exact terms as to enable any person skilled in the art to which it pertains to make and use the same. It will be understood that variations, modifications, equivalents and substitutions for components of the specifically described embodiments of the invention may be made by those skilled in the art without departing from the spirit and scope of the invention as set forth in the appended claims.

I claim:

1. In combination with a motor vehicle, a system for signaling a pair of personal messages by a driver of said motor vehicle in a reward direction, said system comprising:
(a) a first signal indicator having a predetermined shape and energized to intermittently provide a first predetermined color light in said rearward direction, said first signal indicator disposed in a predetermined position and a predetermined distance from one upper corner of a rear window of said motor vehicle, said first color light defining a first personal message;
(b) a second signal indicator having a predetermined shape and energized to intermittently provide a second predetermined color light in said rearward direction, said second signal indicator disposed in a predetermined position and a predetermined distance from said one or an opposed upper corner of said rear window of said motor vehicle;
(c) a third signal indicator having a predetermined shape and energized to intermittently provide a third predetermined color light in said rearward direction, said third signal indicator juxtaposed with said second signal indicator;
(d) at least one switch operatively mounted on one of a steering wheel and a dashboard of said motor vehicle, said at least one switch manually and selectively operable to selectively energize and deenergize said first signal indicator and further selectively operable to selectively energize and deenergize each of said second and third signal indicators, whereby said second and third signal indicators alternatively flash upon activation, said alternative flashing of said second and third signal indicators defining a second personal message; and
(e) wherein each of said first, second and third signal indicators includes a hollow housing having an open side, an adhesive for affixing said housing directly to an interior surface of said rear window and positioning said open side thereabout, a light source mounted within said housing and connected to a source of electric power, said light source operable to emit a light beam upon operation of said at least one switch, and a cover covering said open side of said housing and enabling passage of said light beam therethrough.

2. The system, according to claim 1, wherein said first predetermined color is yellow.

3. The system, according to claim 1, wherein said second predetermined color is green.

4. The system, according to claim 1, wherein said third predetermined color is red.

5. The system, according to claim 1, wherein said light source is at least one of incandescent, halogen and light emitting diode type.

6. The system, according to claim 1, wherein said at least one switch includes a pair of switches mounted on said steering wheel of said motor vehicle, wherein one of said pair of switches is manually operable to selectively energize and deenergize said first signal indicator and wherein one of said pair of switches is manually operable to selectively energize and deenergize each of said second and third signal indicators in an alternative manner.

7. In combination with a motor vehicle, a system for signaling at least one personal message by a driver of said motor vehicle in a reward direction, said system comprising:
(a) a first signal indicator having a predetermined shape and energized to intermittently provide a yellow color light in said rearward direction, said first signal indicator disposed in a predetermined position and a predetermined distance from one upper corner of a rear window of said motor vehicle, said yellow color light defining a first personal message;
(b) a second signal indicator having a predetermined shape and energized to intermittently provide a green color light in said rearward direction, said second signal indicator disposed in a predetermined position and a predetermined distance from said one or an opposed upper corner of said rear window of said motor vehicle;
(c) a third signal indicator having a predetermined shape and energized to intermittently provide a red color light in said rearward direction, said third signal indicator juxtaposed with said second signal indicator;
(d) a first switch operatively mounted on a steering wheel of said motor vehicle and manually operable to selectively energize and deenergize said first signal indicator, wherein an exposed surface of said first switch has said yellow color;
(e) a second switch operatively mounted on said steering wheel of said motor vehicle in juxtaposed relationship with said first switch, said second switch manually operable to selectively energize and deenergize each of said second and third signal indicators, whereby said second and third signal indicators alternatively flash upon activation, wherein an exposed surface of said second switch has a combination of said green and red colors, said alternative flashing of said second and third signal indicators defining a second personal message; and
(f) wherein each of said first, second and third signal indicators includes a hollow housing having an open side, an adhesive for affixing said housing directly to an interior surface of said rear window and positioning said open side thereabout, a light source mounted within said housing and connected to a source of electric power, said light source operable to emit a light beam upon operation of said at least one switch, and a cover covering said open side of said housing and enabling passage of said light beam therethrough.

8. A method of signaling a pair of personal messages by a driver of a motor vehicle in a reward direction, said method comprising the steps of:
(a) mounting a first signal indicator in close proximity to one upper corner of a rear window of said motor vehicle,
(b) mounting a second signal indicator in close proximity to one of said one upper corner and an opposed upper corner of said rear window of said motor vehicle;
(c) mounting a third color signal indicator in a juxtaposed relationship with said second signal indicator;
(d) mounting at least one control switch on one of a steering wheel and a dashboard of said motor vehicle;
(e) operably connecting said at least one control switch to each of said first, second and third signal indicators;
(f) signaling, by way of said first signal indicator, a first personal message; and
(g) signaling, by way of said second and third signal indicators, a second personal message.

9. The method, according to claim 8, wherein said step of signaling said first personal message includes the step of intermittently energizing and deenergizing said first signal indicator.

10. The method, according to claim 8, wherein said step of signaling said second personal message includes the step of intermittently energizing and deenergizing each of said second and third signal indicators in an alternative manner.

11. The method, according to claim 8, wherein said step of signaling said first personal message includes the step of emitting, by said first signal indicator, a predetermined color light.

12. The method, according to claim 8, wherein said step of signaling said second personal message includes the step of emitting, by said second signal indicator, a first predetermined color light and the step of emitting, by said third signal indicator, a second predetermined color light.

13. The method, according to claim 8, wherein said step of mounting at least one control switch includes the step of mounting a pair of switches on said steering wheel.

14. The method, according to claim 11, wherein said method includes the additional step of providing at least an exposed surface of one of said pair of switches with a color substantially equal to a color emitted by said first signal indicator.

15. The method, according to claim 14, wherein said method includes the additional step of providing at least an exposed surface of an opposed one of said pair of switches with each of a first color being substantially equal to a color emitted by said second signal indicator and a second color being substantially equal to a color emitted by said third signal indicator.
